(19) United States
(12) Patent Application Publication
(10) Pub. No.: US 2010/0070241 A1
(43) Pub. Date: Mar. 18, 2010

(54) COMPUTER-BASED METHOD FOR AUTOMATED MODELLING AND DESIGN OF BUILDINGS

(75) Inventors: Per-Olav Opdahl, Asker (NO); Yngve Holte Olsen, Nesbru (NO); Per Christian Engdal, Oslo (NO); Oystein Mejlaender-Larsen, Oslo (NO)

Correspondence Address: NIXON & VANDERHYE, PC, 901 NORTH GLEBE ROAD, 11TH FLOOR, ARLINGTON, VA, 22203, US

(73) Assignee: SELVAAG BLUETHINK AS, Oslo (NO)

(21) Appl. No.: 12/307,837

(22) PCT Filed: Jul. 5, 2007
(86) PCT No.: PCT/NO2007/000261

§ 371 Date: Nov. 24, 2009

(30) Foreign Application Priority Data
Jul. 7, 2006 (NO) 20063163

(51) Int. Cl. G06F 17/50; G06N 5/02

(52) U.S. Cl. 703/1; 706/47

(57) ABSTRACT

A computer-implemented method for producing a data representation of a specific building, in particular in the form of a house instance building information model (house instance BIM), by using a processor. A set of house product configuration data and a configuration rule instruction are retrieved, a first configuration input is received, the first configuration input triggers (a) the application of the at least one configuration rule instruction to the set of house product configuration data by using a configuration program that is executed in the processor to instantiate a configured house instance structure (HIS) formed of a plurality of HIS elements, or (b) the retrieval of a pre-instantiated house instance structure (HIS) and the application of the at least one configuration rule instruction to the set of house product configuration data and to the pre-instantiated house instance structure by using a configuration program that is executed in the processor to produce a configured house instance structure (HIS) formed of a plurality of HIS elements. From a product BIM (PBIM) element data store (160) a plurality of PBIM elements are retrieved, each of which corresponds to a respective HIS element among the plurality of HIS elements. A BIM element instance is created for each retrieved PBIM element by applying to the retrieved PBIM element a parameter value or a relational property on the basis of information carried by the respective HIS element. A house instance BIM is formed by assembling the created BIM element instances.

The invention relates to a computer-implemented arrangement and method for use in building design which, on the basis of house product configuration data representing a set of documents, model files and drawings, are designed to produce a house instance building information model comprising data that may subsequently be utilised for direct production of such documentation as is necessary in a building process.

Within the technical field of the invention there exist well-known and documented techniques in a closely related branch of computer technology known as expert systems. The basis for developments in this branch has been the ability to develop software for general problem solving. In the book Human Problem Solving, Prentice Hall (1972), ISBN: 0134454030, Allen Newell and Herbert A. Simon have described their findings from the development of “The general problem solver”, a system for general problem solving. One of the main results demonstrated by Newell and Simon was that the human way of solving problems can for the most part be described by IF-THEN type rules, described as production rules. In the invention, rules are used which primarily correspond to the said production rules, which, here, in the description of the configuration of house instances in connection with the present invention, are referred to as configuration rule instructions.

A well-known example of the use of production rules for configuration is the system eXpert CONfigurer (XCON), developed by Digital Equipment Corporation (DEC). XCON is a system for the configuration of computers, where a language is used for the description and execution of production rules. In an article by Virginia E. Baker and Dennis E. O'Connor, “EXPERT SYSTEMS FOR CONFIGURATION AT DIGITAL: XCON AND BEYOND”, Communications of the ACM 32, No.3 (1989), the foundation for the execution of production rules is described as a “recognise/act” cycle. The “working memory”, which is a device for storing global status information, represents both input data and result from the production rule action (the THEN part of the rule). The conditions in a production rule (the IF part) specify tests on the “working memory”; if all the conditions are satisfied, the action(s) (the THEN part) of the rule will be executed, which in turn alters the “working memory” in some way or other. By an alteration of the “working memory” is meant updating, deletion or addition of elements in the memory, which corresponds to conditions in the rule. This technique represents a method which in some attributes corresponds to a method for producing a data representation of a specific building, for example, in the form of a house instance building information model (house instance BIM) by using a processor, wherein the method comprises retrieving a set of house product configuration data, retrieving at least one configuration rule instruction, receiving a first configuration input, and responding to the first configuration input by applying the at least one configuration rule instruction to the set of house product configuration data.

The present invention provides a computer-implemented method for producing a data representation of a specific building, in particular in the form of a house instance building information model (house instance BIM), characterized by the features that are set forth in attached claim 1.

Additional features of the inventive computer-implemented method are set forth in attached claims 2 to 5 inclusive.

The present invention farther provides an arrangement comprising one or more functional elements, wherein the one or more functional elements are designed, when in operation, to perform the method disclosed in one of claims 1 to 5 inclusive.

The present invention further provides a computer program product which comprises computer-readable program instructions, wherein the computer program product is designed so that when the program instructions have been read into the computer thereby allowing them to be executed by using at least one computer processor, the computer is enabled to perform the method disclosed in one of claims 1 to 5 inclusive.

In this description, the invention is referred to generally as “the intelligent house configurator” (IHC), which alludes to the fact that the invention constitutes a house configurator which, by use of software run in a computer and work methods, makes it possible to
a) define a house product;
b) configure a single house into a house instance through simple user dialogues; and
c) document the house instance,
   through the assembly of a house instance building information model (“house instance BIM”, or HBIM) 100.

The invention will be described in more detail with reference to the attached figures, wherein the reference numerals and letters used indicate the same elements in all the drawing figures, and wherein:

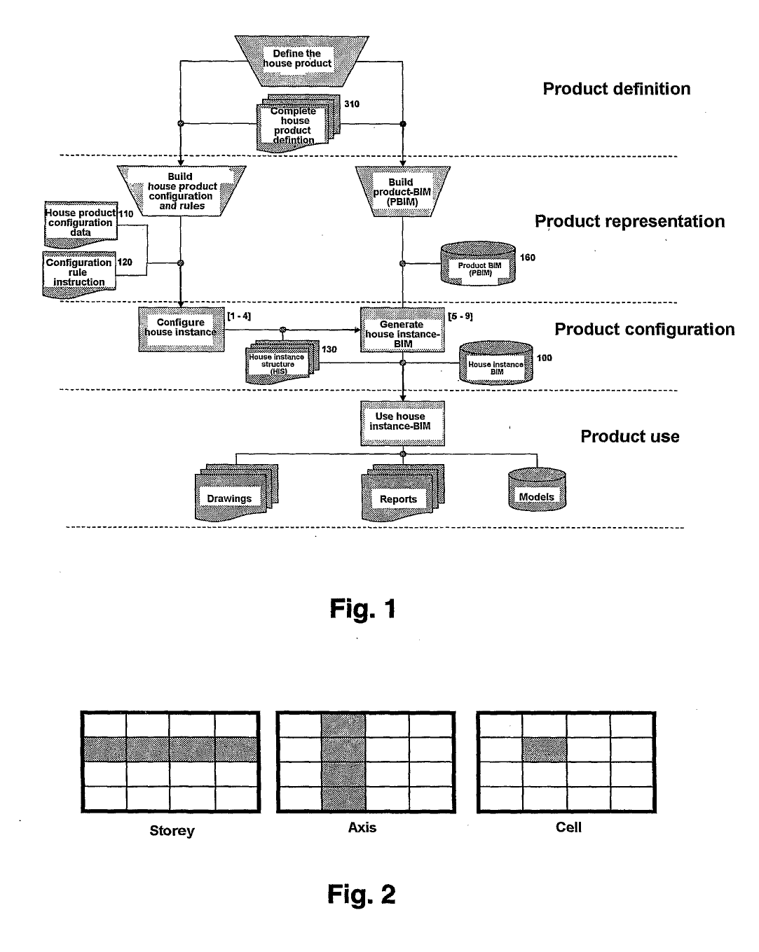

FIG. 1 is a schematic representation of an extended process that includes the invention for producing documentation for the implementation of a building process;

FIG. 2 illustrates a model example to explain a relational property of a BIM element instance which is produced through the use of the invention;

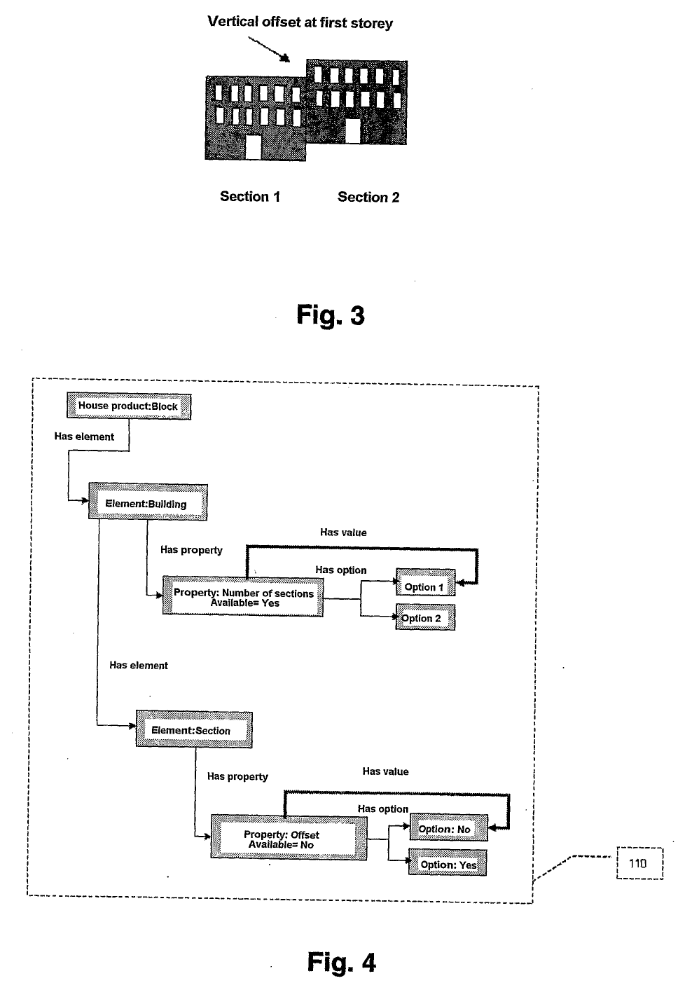

FIG. 3 illustrates an example of a house product employed to explain the invention;

FIG. 4 is a schematic illustration which, though the use of an example, is employed to explain house production configuration data;

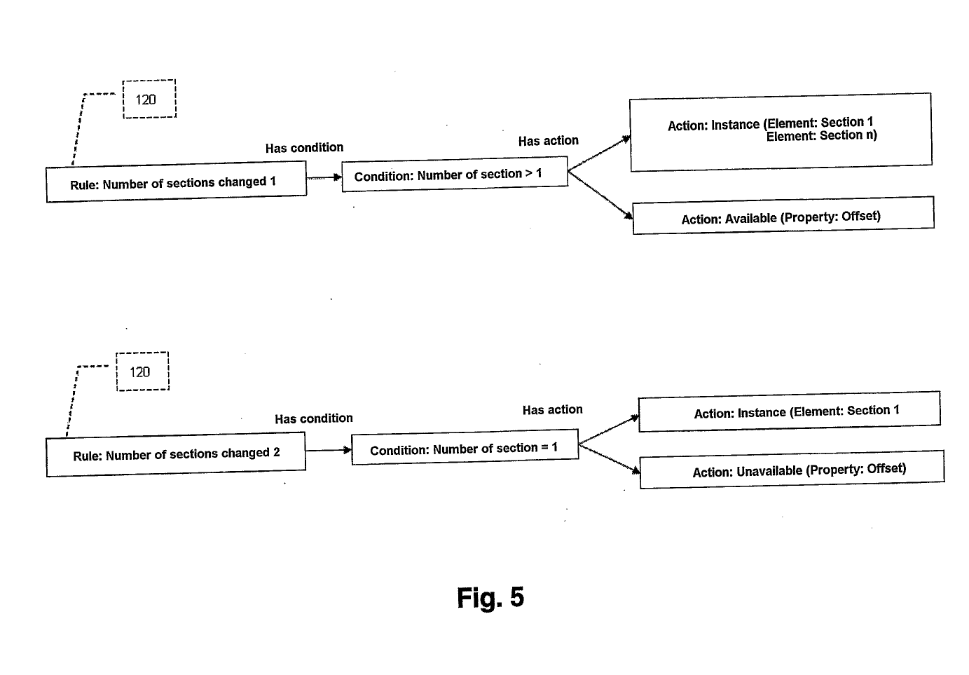

FIG. 5 is a schematic illustration which, through the use of an example, is employed to explain a configuration rule instruction;

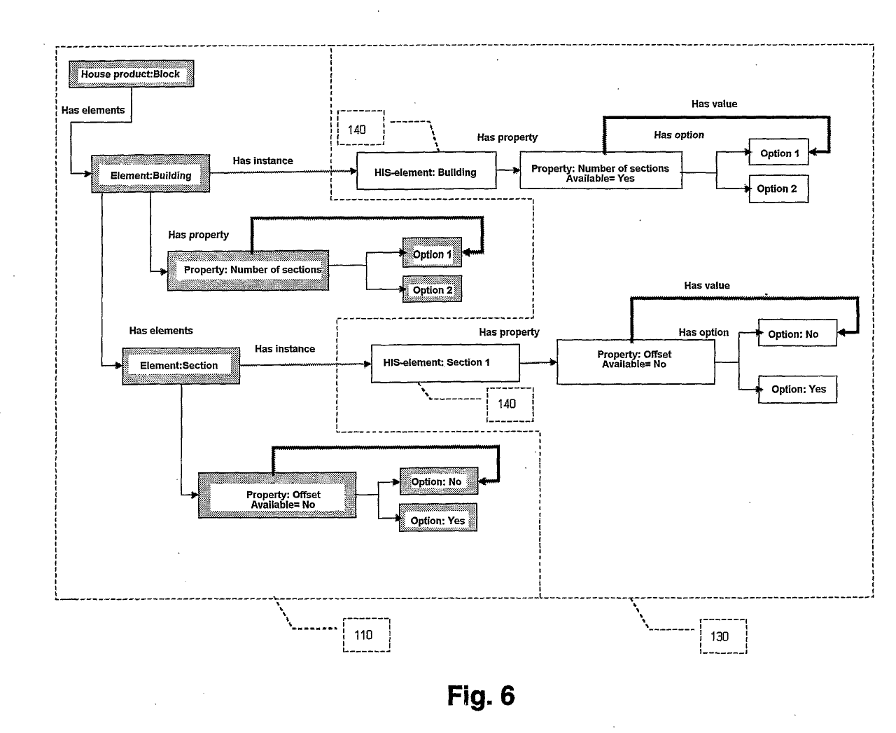

FIG. 6 is a schematic illustration which, through the use of the example in FIGS. 3 and 4, is employed to explain the application of a configuration rule to house product configuration data at an input stage of a configuration of a house instance;

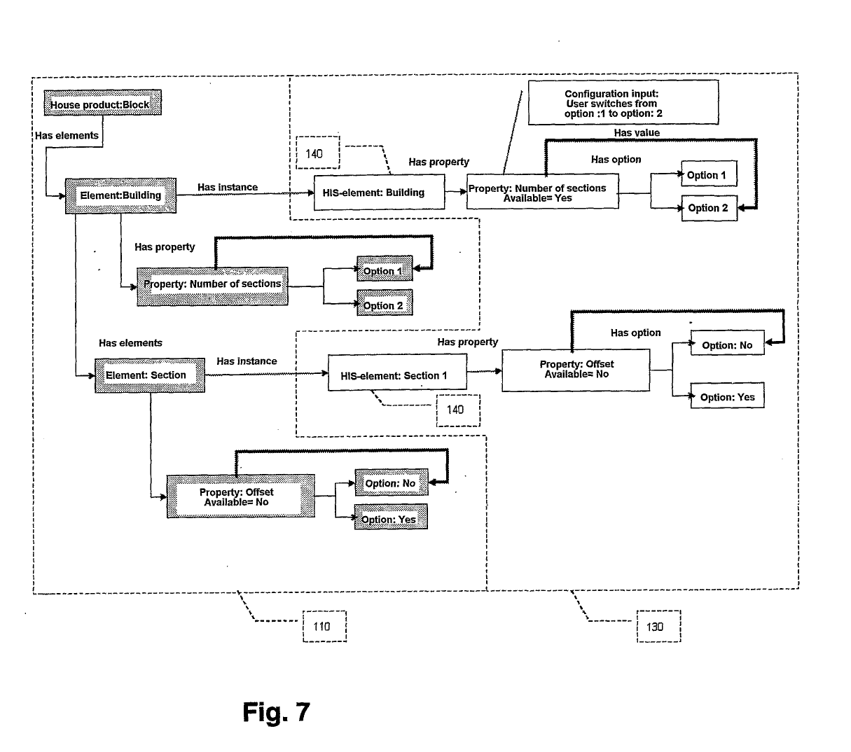

FIG. 7 is a schematic illustration which, through the use of the example in FIGS. 3 and 4, is employed to explain a user input entered through a user dialogue in a first stage of the implementation of a configuration of a house instance;

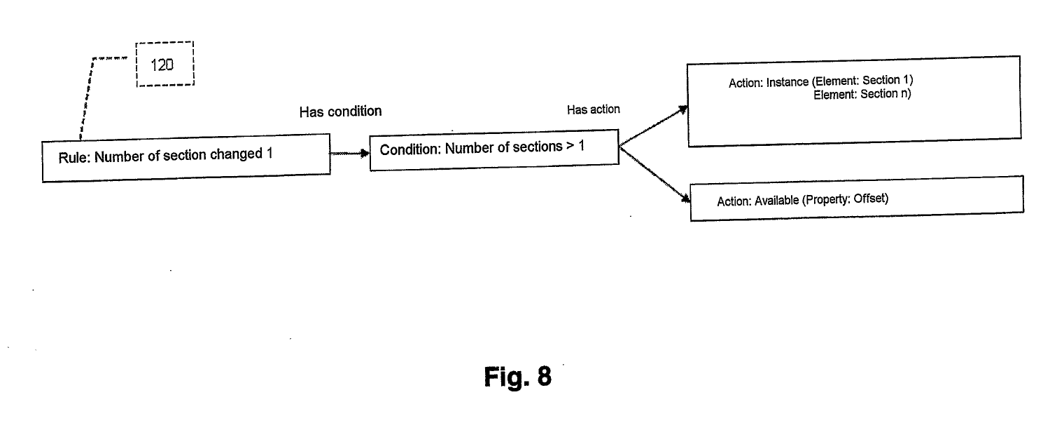

FIG. 8 is a schematic illustration which, through the use of the example in FIGS. 3 and 4, is employed to explain the introduction of a configuration rule at a second stage of a configuration of a house instance;

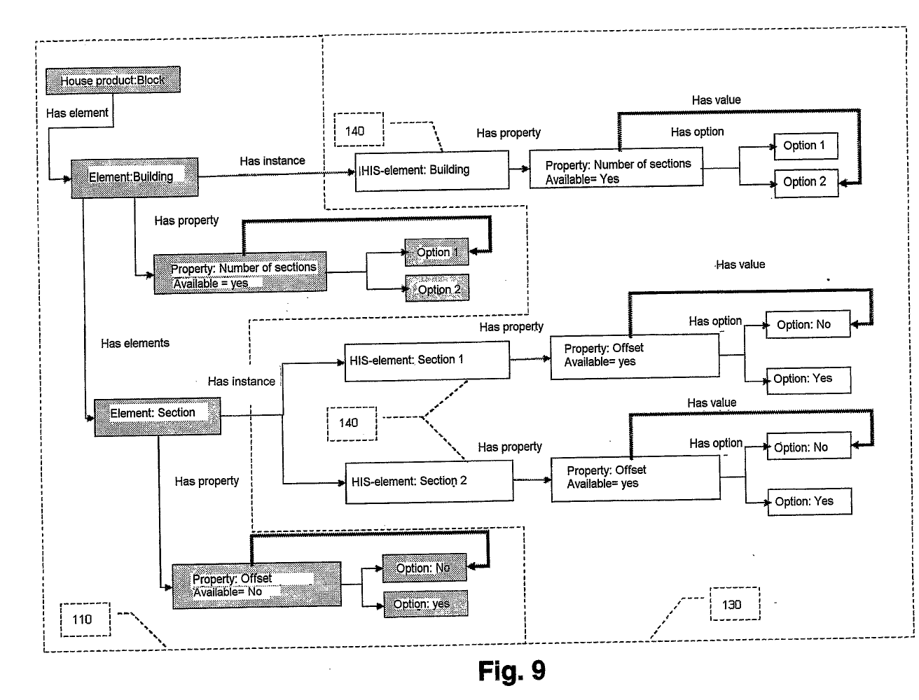

FIG. 9 is a schematic illustration which, through the use of the example in FIGS. 3 and 4, is employed to explain the application of a configuration rule to house product configuration data at a third stage of the implementation of a configuration of a house instance;

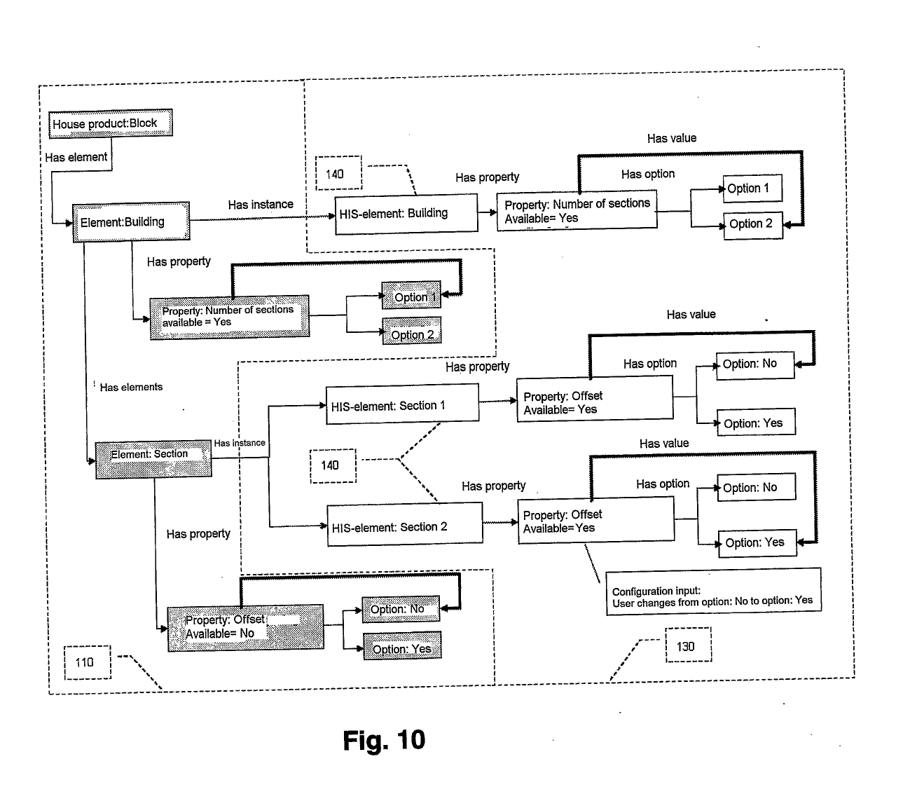

FIG. 10 is a schematic illustration which, through the use of the example in FIGS. 3 and 4, is employed to explain the use of a user input entered through a user dialogue at a fourth stage in a configuration of a house instance;

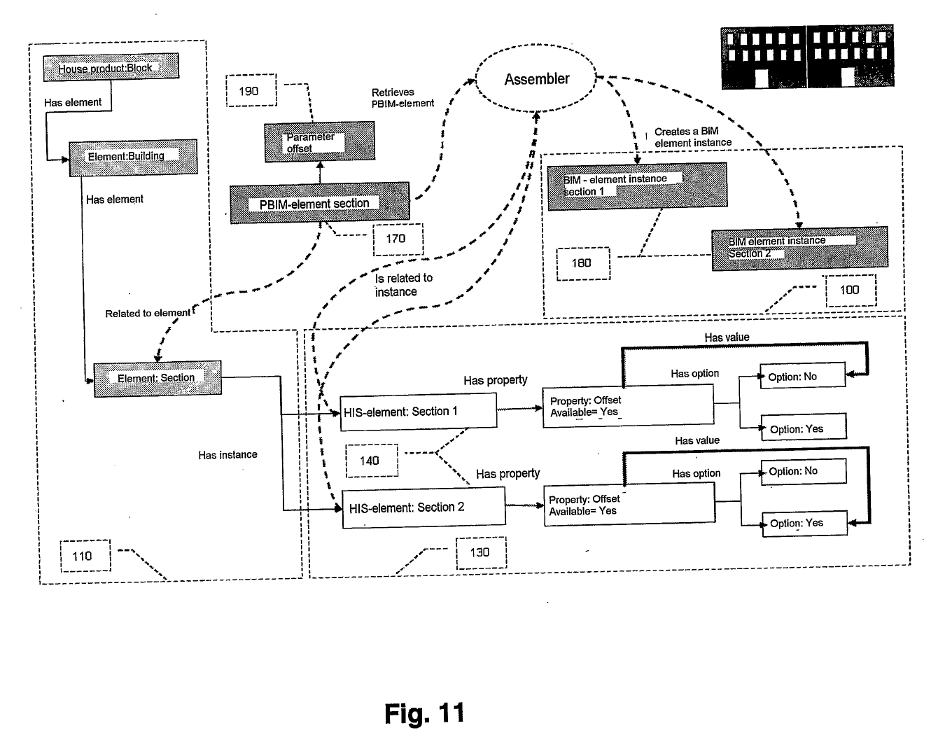

FIG. 11 is a schematic illustration which, through the use of the example in FIGS. 3 and 4, is employed to explain the creation of a BIM element instance when generating a house instance BIM; and

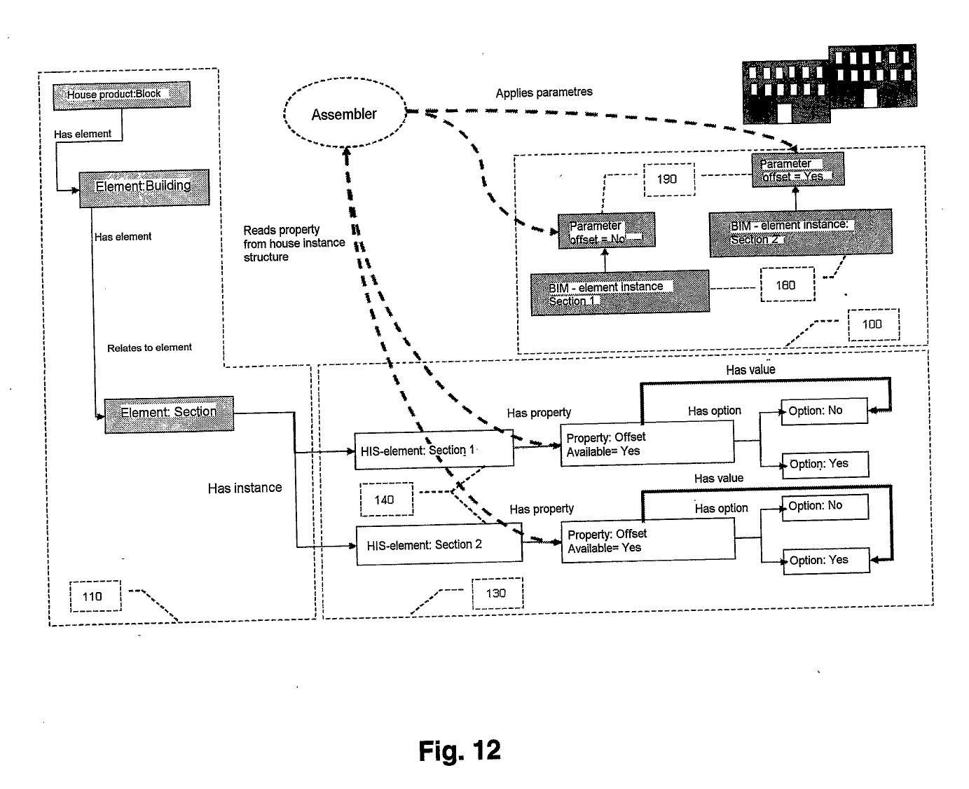

FIG. 12 is a schematic illustration which, through the use of the example in FIGS. 3 and 4, is employed to explain the establishment of the application of a parameter when generating a house instance BIM.

With reference to FIG. 1, there first follows a brief description of an extended process which comprises the inventive method for preparing documentation for the implementation of a building process. FIG. 1 and the following explanation will provide the necessary guidance for producing an arrangement for performing the process that is explained.

The house product is defined as a set 310 of documents, model files and drawings which form a complete description of the house product with the defined options and choices. This complete description of the house product is used as input information for the process “Build house product configuration and rules”. The result of the process “Build house product configuration and rules” is a set of house product configuration data describing the structure of the house product 110 and what configuration rules 120 are to apply for the house product.

The house product definition 310 is used also as a basis on which to establish a product BIM (PBIM) 160 by using a suitable description tool for a digital geometrical design. A suitable description tool may typically be a CAD tool (Computer-Aided Design) which by manual or data-controlled interaction builds geometric elements from the house product definition. A geometric element may be static, or it may be parametrized so that the element can change its geometric behaviour in response to parameter value changes.

This PBIM is built up of PBIM elements where each individual PBIM element describes a subset of the house product, so that any house instance can be described by putting together one or more PBIM elements in a house instance BIM.

The set of house product configuration data 110 and configuration rule instructions 120 are read automatically into a rule-based configurator [1,2,3,4] which creates, under the control of the configuration rule instructions 120, simple user dialogues through which the user must choose between the options which are valid at any given time and in so doing give the first configuration rule input [2.1], and put together a house instance structure (HIS) 130 as described in the house product configuration data 110 and the configuration rule instructions 120

The HIS 130 is read automatically by the assembler [5,6,7,8,9] which, on the basis of HIS elements 140 from HIS 130 and PBIM elements 170 from PBIM 160, assembles a complete house instance BIM 100. During the automated process, the assembler will retrieve PBIM elements 170 related to the individual HIS element 140 and give the PBIM element a set of parameter values or apply a set of actions to the element, so that the BIM element instance 180 that is derived will be given the correct geometric values and positions, and thus constitute a complementary subset of the resultant house instance BIM 100. Once all BIM element instances have been derived, the house instance BIM 100 will be a complete and consistent house instance BIM 100. This automated process will in its entirety replace a traditional and manual modelling of a house instance BIM in a suitable CAD tool.

The finished house instance BIM 100 may then be used to gather and generate necessary documentation that is required in a building process. Such documentation is typically 1:100 and 1:50 drawings, reports and quantities and model representations such as dwg- and IFC-based models.

For the further explanation of the invention a number of terms will be described in more detail below.

House instance building information model (house instance BIM) 100 consists of a collection of information elements with relations that describe a building. The building is described by a set of properties. Such properties may be geometry, material, product identities of elements in the building and descriptions of work processes for producing the described building, but are not limited thereto.

House product configuration data 110 is a set of configuration data which together describes how a house product may be configured in a number of house instances. A configurable property/function may be number of storeys, number of sections, heating type, colour variant etc., but are not limited thereto.

Configuration rule instruction 120 is a construction used to describe dependencies, relationships and constraints in a set of house product configuration data and an associated house instance structure. It uses the following logic structure: If <Condition> then <Action>, where <Condition> may be a logical expression which expresses dependencies, relationships and constraints in a set of house product configuration data and <Action> describes the instruction that is to be carried out when <Condition> occurs. To execute configuration rule instructions, a rule engine can be used.

House instance structure (HIS) 130 is a collection of HIS elements which together describe a configuration of a house instance.

HIS element 140 is an instance of a defined house product configuration element. The HIS element will identify which PBIM element must be used to be able to build a BIM that satisfies the configuration the HIS element describes. The HIS element will thus also contain necessary parameters and relations that the PBIM element must have applied thereto.

Product BIM (PBIM) 150 is a collection of PBIM elements, which when assembled in accordance with a house instance structure can form one (or more) house instance BIMs.

PBIM element data store 160 is a data store that contains a collection of PBIM elements.

PBIM element 170 is an identifiable and unique collection of information elements, which typically represent respective physical building components or real actions that are to be carried out, and their properties. Typical examples of a PBIM element are a wall, a window, a storey and a roof, or an action, but are not limited thereto. Examples of typical properties are geometry, weight, material, and insulating quality, but are not limited thereto. A PBIM element may also contain an action, but need not do so.

BIM element instance 180 is an identifiable and unique collection of information elements and their properties that are derived from a single PBIM element. The single PBIM element can be differentiated to many BIM element instances, but each individual BIM element instance will be unique as a consequence of having had a parameter or a relational property applied thereto.

Parameter 190 is a value that is applied to a BIM element instance so that the BIM element instance changes one or more properties. Such a property may be the length of a wall, a colour of a surface, or part of an identity, but is not limited thereto.

Relational property 200 is a property of a BIM element instance which stands in relation to another BIM element instance. Such a property may, for example, be a relative position such as the relational property of element x to element y is that element x is positioned above element y. A relational property may also apply a change of the element's property, such as, for example, if the position of element x is above element y, one of element x's properties is changed so that element x is adapted to element y. A relational property is however not limited to these examples.

Storey element, axis element and cell element are used as designations for elements in a house structure, as illustrated in FIG. 2. In a house structure which consists of several storeys and several axes, the element that is common to an intersecting storey and axis is called a cell element.

The following explanation of the invention is made using an example of a house product of the type apartment block, wherein the product is defined as consisting of one or more sections, with options for configuring the number of sections it may consist of, and of whether these sections are to be offset vertically relative to each other.

Thus, FIG. 3 illustrates a configuration of this house product example, wherein two sections are selected, and wherein section no. 2 is offset one storey in the vertical direction relative to section no. 1.

This example (apartment block) is used to explain the different stages in a computer-implemented method according to the invention in order, in an automated manner, by using a data processor, to create a house instance BIM, from a house product.

The method according to the invention comprises first reading [1], typically from a first data store, a set of house product configuration data 110.

House product configuration data is data indicating the alternatives that are available for the configuration of a house product, i.e., indicating the options a user will have as regards putting together a desired house instance.

House product configuration data can be divided into the following entities:
Element: Indicates a part of a building. An element can consist of sub-elements, and a house product will be an aggregation of defined elements. Examples of elements are building, section, storey and apartment.
Property: Indicates a property of an element. The collection of properties for all elements of a house product indicates what can be configured on the product. Examples of properties are number of storeys, number of sections and type of apartment.
Option: Indicates option alternatives offered for a property. The collection of options for all properties defines the total scope of variation for a product. Examples of options for properties are number of storeys: 1 to 4, type of apartment: 2-room, 3-room.

For the house product in the example used in this explanation, configuration data may be represented as shown in FIG. 4.

From FIG. 4 it can be seen that the house product “Block” comprises two elements “Building” and “Section”, where “Building” represents the building as a whole, and “Section” is a sub-element of building. Two properties for configuration are defined, namely “Number of sections”, as related to the building element and “Offset”, as related to a section.

For the property ‘Number of sections’ two option alternatives are defined which are respectively “Number of sections 1”, which in this example is defined as a standard value, and “Number of sections 2”.

For the property “Offset” two option alternatives are defined which are “No” and “Yes” respectively. In this example “No” has been set as the standard value.

Each of the elements defined in house product configuration data may, upon completed configuration, be represented as house instance elements (HIS element) in a house instance structure (HIS structure). The HIS elements are designed so that they inherit properties that are defined for the elements.

Furthermore, the method according to the invention comprises reading [2], typically from a second data store, at least one configuration rule instruction 120.

A configuration rule instruction indicates the actions that are to be carried out on a house instance structure on the basis of occurrences and conditions in the house instance structure. In this example, as shown in FIG. 5, two possible configuration rule instructions are indicated.

to A first of the two rules, called here “Number of Sections Changed 1”, indicates that if the state of the house instance structure is such that the property “Number of sections” is more than one, then a number of instances of the element “Section” should be created, where the property “Offset” should be a possible option for all the instances.

A second of the two rules, called here “Number of Sections Changed 2” indicates that if the state of the house instance structure is such that the property “Number of sections” is exactly one, then only exactly one instance of the element “Section” should be created, and it should not be possible to select the property “Offset”.

The method according to the invention further comprises receiving [2.1] a first configuration input,

responding [3] to the first configuration input by
a) applying the at least one configuration rule instruction 120 to the set of house product configuration data 110 by using a configuration program which is executed in the processor to instantiate [4.1] a configured house instance structure 130 (HIS) formed of a plurality of HIS elements 140; or
b) retrieving a pre-instantiated house instance structure (HIS) and applying the at least one configuration rule instruction 120 to the set of house product configuration data 110 and to the pre-instantiated house instance structure by using a configuration program that is executed in the processor to produce [4.2] a configured house instance structure 130 (HIS) formed of a plurality of HIS elements 140.

The application of a configuration rule instruction or instructions, may result in changes of state in the house instance structure. By change of state is meant either enlarging or reducing the house instance structure based on house product configuration data 110, or by changing a property value in the house instance structure.

With reference to FIGS. 6 to 10 inclusive, an explanation is given, by using the same building example, of the application of a configuration rule instruction in relation to the example. Here states and occurrences are described through five stages, indicated by T0 to T4 inclusive.

Reference is first made to a starting stage, T0, which, illustrated in FIG. 6, depicts the initial state of the house instance structure.

In this example (apartment block), we choose to start with an initial state in which there exists an instance of respectively the elements building (“Building”) and section (“Section 1”). The property “the value of number of sections” for the instance “Building” is set at 1, which instance is designated as “Section 1”. The property “Offset” for the instance “Section 1” is, as can be seen from the figure, unavailable.

Reference is then made to a first stage, T1, which, illustrated in FIG. 7, depicts how the value of number of sections is set at 2 via a user dialogue that is established.

An external stimulus, or occurrence, is received through the established user dialogue, so that the value of the property number of sections in the building is adjusted from 1 to 2.

Reference is then made to a second stage which, illustrated in FIG. 8, depicts how a rule for the change in number of sections is carried out.

In the case that the value of the number of sections is set at 2, the condition in the rule “Number of Sections Changed 1” will become applicable. Two actions will be performed. In a first action, a new instance for the element “Section” is created, which is called “Section 2”, and in a second action, the availability values for the property “Offset” are adjusted from “No” to “Yes” for both sections.

Reference is then made to a third stage, T3, which, illustrated in FIG. 9, depicts the state after the application of the rule “Number of Sections Changed 1”.

As can be seen from FIG. 9, there are now two instances of the element “Section”, which two instances are “Section 1” and “Section 2”, respectively. For both sections the property “Offset” is made available, and the standard option “No” is set in both cases.

Reference is now made to a fourth stage, T4, which, illustrated in FIG. 10, depicts how “Offset” is selected for “Section 2” via a user dialogue.

Here the choice is made to offset section 2 in relation to section 1, and this property is therefore set at “Yes”.

No rule has been defined for changing this property, but the state of the house instance structure has been changed.

The method according to the invention further comprises
retrieving [5] from a PBIM element data store 160 to the processor data memory at least one PBIM element 170 that corresponds to a respective HIS element among the plurality of the HIS elements 140;
creating [6] a BIM element instance 180 for each retrieved PBIM element 170; and
forming [8] a house instance BIM 100 by assembling [9] the created BIM element instances 180, wherein the BIM element instances 180 that are created are provided [10] with information that determines a selection of PBIM elements 170.

PBIM elements represent parts of the house product. In the example there will be a PBIM element for “section” that is related to the element “Section” in the house product configuration data. A PBIM element may be arranged to receive parameter values, to control the behaviour of the element. The following figure illustrates the relationship between configuration data, house instance structure and the PBIM element in the example.

Furthermore, the method according to the invention may include, as illustrated in FIGS. 11 and 12; applying [7] to the retrieved PBIM element 170 a parameter 190 or a relational property 200; and
adapting [11] adjacent BIM element instances 180 geometrically and/or functionally to each other.

Since the house instance structure for “Section 2” now, in this example, indicates that this element is to be offset, this is indicated as an “Offset” parameter of the respective BIM element instance for “Section 2”, so that the desired geometric position is obtained through a change in the geometric position values of the BIM element.

The following description of other aspects and example explanations of the present invention is based on and is a further development of the description of the invention given in the above text, which corresponds to the description in the present applicant's priority application NO20063163, which description is given in its entirety above.

In the following, the present invention is explained by further elaboration and examples, with the aid of the attached additional drawings wherein:

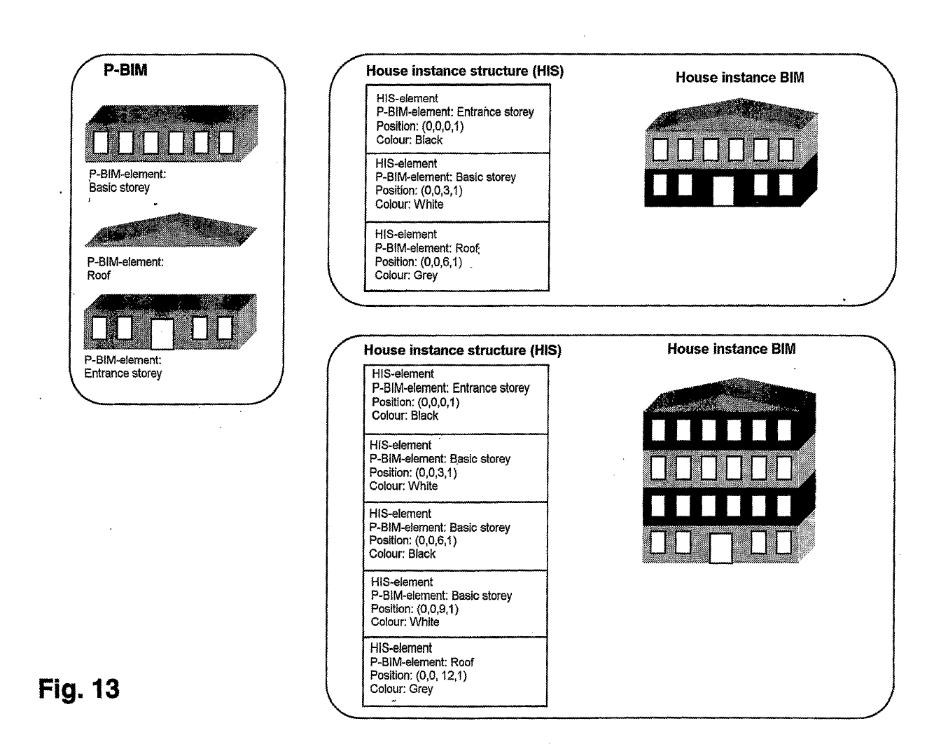

FIG. 13 illustrates schematically an example of a PBIM, with three PBIM elements and two different HIS, each with its respective assembled house instance BIM; and

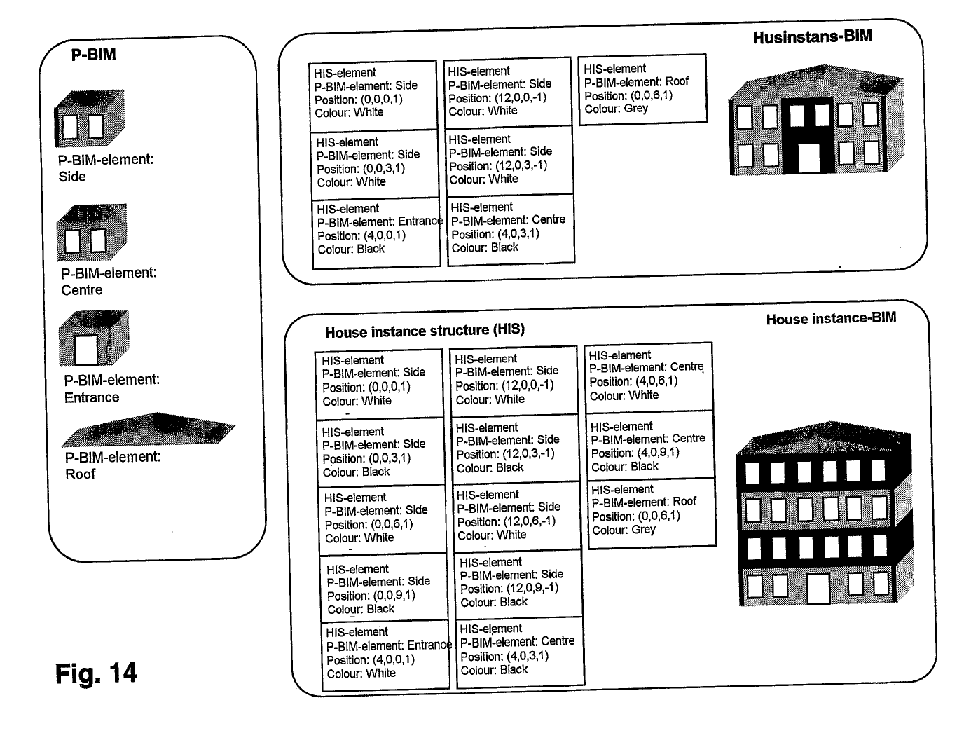

FIG. 14 illustrates schematically a second example of a PBIM, with four PBIM elements and two different HIS, each with its respective assembled house instance BIM.

As a result of applying the configuration rule instruction to the set of configuration data, the HIS elements are created. The individual HIS element is created with such identification and location information as is necessary to be able to identify and locate a respective PBIM element. This identification and location information can appear in different ways, but will in an advantageous implementation of the invention usually appear through an entry in a reference work which holds identification and location information, as a result of the execution of one or more the aforementioned rules, or as a result of a computation.

In one intended implementation of the present invention, the PBIM element will typically be represented as a CAD model (computer-aided design model), where the CAD model is characterized in that it can be positioned in a geometric reference system, which, for example, may be a Cartesian coordinate axis system, with the aid of one set of geometric position parameters. Such position parameters will, for instance, when a Cartesian coordinate system is chosen as reference system, comprise x-, y- and z-coordinates, and a directional indication. For the CAD model, it will be sufficient to have one, and just one, set of position parameters. In a computer-implemented realisation of the present invention, the CAD model can preferably be represented and stored in a CAD model data file in a suitable data file format, as for instance one of the data file formats which are known to a person of skill in the field by the following letter combinations in the name extension of the data file: “.DWG”, “.DGN” og “.IFC”. In an alternative realisation of the present invention, the CAD model, instead of being represented in a CAD model data file, as stated above, may be represented as a data object, a data structure or a data file in a database or the like.

According to the present invention, the HIS element is given the information which in the chosen implementation is necessary for instantiating, positioning and changing the given PBIM element, on the basis of which information a BIM element instance is created. This information always comprises the aforementioned position parameters, such as the x-, y- and z-coordinates, as well as direction, in the case where a Cartesian coordinate system is used. The said position parameters determine the geometric positioning of the created BIM element instance in relation to the defined basic reference point of the house instance BIM to which the created BIM element instance is related. In a realisation of the invention where a Cartesian coordinate system is used, origo will be a typical reference point. In one advantageous embodiment, the HIS element information will also contain other parameters and/or relational properties which are imparted to the BIM element instance that is created on the basis of the HIS element. The HIS element information can be represented in the HIS element by parameter names and values that are represented basically unchanged in a BIM element instance created on the basis of this HIS element. Alternatively, parameter names and values can be represented in the HIS element in such manner that the corresponding, created BIM element instance exhibits parameters and values that are produced by computation through the creation of the BIM element instance. Such computation is however not limited to position parameters, but can also be used for other parameters.

According to a computer-implemented realisation of the present invention, the house instance elements are read from a house instance structure (HIS). When the HIS elements are read from a relevant HIS, each read HIS element will be used to first retrieve the respective PBIM element to which the individual HIS element refers. Each retrieved PBIM element is then read into a CAD tool to which the PBIM element is adapted. The CAD tool that is typically used when implementing the present invention is arranged so that the CAD model which at any given time represents a retrieved PBIM element that is read into the CAD tool is assigned a unique identifier, optionally a unique position, so that two otherwise identical CAD models which have been read in from the same CAD model file on the basis of two different HIS elements can co-exist and appear in the CAD tool as two different instances of the same CAD model file.

According to the present invention, the aforementioned co-existence is obtained in at least one of the following ways:
1. Real changes are made in the model file before it is read into the CAD tool;
2. The CAD tool is instructed to read in the CAD model file by using a particular set of parameter values; or
3. The CAD tool is instructed to read the model file, and the CAD tool is instructed to set the CAD model parameters using a suitable functionality interface in the CAD tool.

Which one of the three aforementioned alternatives that is chosen in the individual case will primarily be determined by the properties of the CAD tool that is used. It is however intended that the HIS element should be provided with information that is sufficient to allow it to be used in any of the three aforementioned alternatives.

After reading in all the HIS elements of the house instance structure and the subsequent creation of all the corresponding BIM element instances, as described above, a complete house instance BIM is created. With the inventive method, the created, complete house instance BIM will be able to consist of a number of BIM instance elements, where each of the BIM instance elements can have its origin in the same PBIM element, whilst other BIM instance elements will have their origin in different, or more, PBIM elements. Similarly, different house instance structures can be used with the same PBIM and result in different house instance BIMs.

To illustrate the aforementioned conditions, reference is made to FIG. 13, which illustrates an example of a PBIM with three PBIM elements which, when used together with two different house instance structures, results in two respective, different house instance BIMs.

As a further example of the aforementioned conditions, reference is also made to attached FIG. 14, in which example there is a PBIM with four PBIM elements which, when used together with two different house instance structures according to the invention, results in the production of a total of two, respectively different house instance BIMs.

To further explain the examples that are illustrated in attached FIGS. 13 and 14, “entrance storey”, “basic storey”, “side”, “centre” and “roof” represent examples of identification and location information which is defined in the respective HIS element for an “addressing” when the respective PBIM element is to be read into the CAD-tool, whilst “position” and “colour” represent the two parameters which from the house instance structure elements of the example are applied to respective PBIM elements on the creation of the respective BIM element instance. The example's parameter “position” assumes values for three position coordinates and one direction, where, for example, a directional value minus 1 indicates a mirroring in a vertical plane.

The implementations of a CAD model and a CAD model file for use with the present invention will typically be determined by the CAD tool that is used. However, it is typical for a CAD tool that a CAD model describes a three-dimensional (3D) model, as it appears in the CAD tool. The CAD model can typically also consist of one or more sub-models that are interrelated, optionally sub-models which are independent of each other. For example, a CAD model, or CAD model file, may represent a finished article, such as a house, but may in other implementations or parts of one of the aforementioned implementations also represent something that is not finished or something that cannot be presented in the material produced by the invention before the CAD model has been put in a context that is determined by the house instance structure. The choice of CAD tool will therefore determine what the individual CAD model in reality comprises, how it is represented, the constraints that apply and the like. It should be noted that the CAD tools which can be used in connection with the present invention have in some cases CAD model libraries or so-called object libraries available. These libraries are libraries of CAD models or CAD sub-models, and are provided in the CAD tool to permit the CAD model or the CAD sub-model to be reused during the performance of the present inventive method. When performing the inventive method in connection with a CAD tool as mentioned above, a relevant CAD model will be identified by, and optionally correspond to, one of the invention's PBIM elements.

With reference to attached FIGS. 13 and 14, a more detailed explanation is given in this paragraph of the relationship between a PBIM element and a CAD model with the aid of an example. In an advantageous embodiment of the present invention, a CAD tool is used which comprises functionality such that the relevant CAD models, besides being related to a corresponding PBIM element, can also be related to a corresponding BIM element instance. For example, a PBIM element will therefore typically have a geometric position (x, y, z=0, 0, 0) in relation to its own origo, whilst a respective BIM element instance will have a geometric position with values for x, y, z given absolutely in relation to the origo that is determined for the house instance BIM. This may, for example, be a building so configured that a BIM element instance for one “axis module” must be placed in the third storey, third axis. If x,y,z are given in metres, the position of the “axis module” will be 21,0,6, where the axis width is 7 metres in the x-direction, and the storey height in 3 metres in the z-direction. Thus, a collection of PBIM elements in a collective display will not be capable of being separated from one another geometrically, and nor will they be assigned other characteristics, i.e., parameter values, such as colour, length, etc. Described by means of a specific example, a PBIM element identified as a “brick wall” may therefore have the position x,y,z=0, 0, 0 and height=2.42, width=0.20 and length=0, in other words, seen in a physical perspective this would be a non-existent object if it were to be presented physically because its length is 0. In the present invention, the instantiated PBIM element “brick wall” will, for example, be given the parameter values position 7, 0, 3 and height 2.42, width 0.20 and length 14, which is possible to represent physically, as this BIM element instance of the PBIM element “brick wall” in the house instance BIM in question will be the specific brick wall in axis 1, second storey, having a length of 14 metres.

On the basis of the aforementioned description, a person of skill in the art will understand that the functionality that is comprised by the present inventive method or arrangement will be capable of being provided through a chosen CAD tool. The chosen CAD tool may therefore provide functionality which wholly or partly effects the aforementioned reading in of each HIS element from the respective house instance structure. The practical realisation of retrieving a plurality of PBIM elements from a PBIM element data store, each of which corresponds to a respective HIS element in the configured house instance structure can thus be realised by using a programmed interface in the selected CAD tool which the invention can use to give commands to the CAD tool, which causes the CAD tool to read the specific CAD model files from a data store into a working memory, and/or commands that ensure that the necessary change or changes of parameters are made on the relevant CAD models. An alternative that has been found advantageous for the realisation of the invention, and which has been indicated above, is to use CAD tool commands which change the necessary parameter values on the relevant CAD model before the relevant CAD model file or files in reality are read in by the CAD tool. In a practical implementation of the invention, where a data file type is used that is known by the skilled person as a “.DWG”-file, the present invention can effect the reading of a corresponding .DWG-file and change position parameters, before the instantiated CAD model is read to a temporary .DWG-file, which then in practice is read in through a data call to the CAD tool.

As mentioned above, the HIS element is given the information that is necessary to be able to instantiate, position and change the given PBIM element for forming the respective BIM element instance. In a current realisation of the present invention, the HIS element is such that it is represented in today's product known under the name “Supervisor”, which is an example of how the invention is produced as a computer-implemented data entity with properties, and when the rules are executed, the properties of the HIS elements have values applied thereto. Referring to the specific examples mentioned above, the data entity “HIS element” may have the property “position (x, y, z)”, and on execution, the position can then be given values, such as (2, 5, 7). In a computer-implemented method or arrangement according to the present invention, a HIS element will typically be an object in an object structure or the like, so that it would normally be understood by one who is skilled in the field of data technology.

According to the description above, each HIS element will be processed by first retrieving the PBIM element to which the HIS element refers when the HIS elements are read from the configured house instance structure. In an advantageous embodiment of the present invention, the HIS element, as stated above, will be understood as a data object which by means of the values of its properties provides a basis for the action that it to be carried out. It will preferably be an executing computer program that ensures the performance of the action that is to be carried out. A typical action may be “read in” a referred-to PBIM element, or “set indicated value for the PBIM element's corresponding parameter” etc., and through these actions the referred-to PBIM element is instantiated so that a BIM element instance is formed in accordance with the action that is carried out.

1. A computer-implemented method for producing a data representation of a specific building, in particular in the form of a house instance building information model (100) (house instance BIM), by using a processor, which method comprises
[1] retrieving a set of house product configuration data (110);
[2] retrieving at least one configuration rule instruction (120);
[2.1] receiving a first configuration input,
characterized by
[3] responding to the first configuration input by
[3.1] applying the at least one configuration rule instruction (120) to the set of house product configuration data (110) by using a configuration program which is executed in the processor to [4.1] instantiate a configured house instance structure (HIS) (130) formed of a plurality of HIS elements (140); or
[3.2] retrieving a pre-instantiated house instance structure (HIS) and applying the at least one configuration rule instruction (120) to the set of house product configuration data (110) and to the pre-instantiated house instance structure by using a configuration program that is executed in the processor to [4.2] produce a configured house instance structure (HIS) (130) formed of a plurality of HIS elements (140);
[5] retrieving from a (150) product BIM (PBIM) element data store (160) a plurality of PBIM elements (170), each of which corresponds to a respective HIS element among the plurality of HIS elements (140);
[6] creating a BIM element instance (180) for each retrieved PBIM element (170) by
[7] applying to the retrieved PBIM element (170) a parameter value (190) or a relational property (200) on the basis of information carried by the respective HIS element (140); and
[8] forming a house instance BIM (100) by [9] assembling the created BIM element instances (180).

2. A method according to claim 1, wherein the HIS structure (130) [10] is provided with information that determines a selection of PBIM elements (170) from the PBIM element data store (160).

3. A method according to claim 1, wherein the PBIM element (170) is arranged as a parametrized PBIM element (170) or a specific PBIM element (170).

4. A method according to claim 1, wherein at least one of the plurality of HIS elements (140) is a storey element, an axis element, cell element or an apartment element.

5. A method according to claim 1, wherein the BIM element instance (180) comprises geometric data which permits a visual presentation of the house instance BIM (100) that is formed.

6. A method according to claim 1, wherein applying the at least one configuration rule instruction (120) to the set of house product configuration data (110) comprises creating a HIS element with identification and location information which identifies and locates a respective PBIM element.

7. A method according to claim 6, wherein the identification and location information is provided by an entry in a reference work which holds identification and location information, as a result of executing one or more of the aforementioned rules, or as a result of a computation.

8. A method according to claim 1, wherein the retrieved PBIM element (170) is represented as a CAD model.

9. A method according to claim 8, wherein retrieving from a (150) product BIM (PBIM) element data store (160) a plurality of PBIM elements (170) is carried out by a CAD tool that is adapted to a CAD model.

10. A method according to claim 9, further comprising assigning through the use of the CAD tool a unique identifier to the CAD model which at any given time represents a retrieved PBIM element that is read into the CAD tool.

11. A method according to claim 1, wherein the parameter (190) comprises both a position determined by a set of coordinate values and a direction determined by a set of direction data.

12. A method according to claim 11, wherein the set of coordinate values is defined in a Cartesian coordinate system.

13. A method according to claim 1, wherein the HIS element is an object in an object structure or the like.
